(19) United States
(12) Patent Application Publication
(10) Pub. No.: US 2007/0299837 A1
(43) Pub. Date: Dec. 27, 2007

(54) Data Processing Method and System Based on Networked Relational Dimension

(75) Inventors: Xue Qiao Hou, Beijing (CN); Gang Hu, Beijing (CN); Bo Li, Beijing (CN); Tao Liu, Beijing (CN); Yue Pan, Beijing (CN)

Correspondence Address: BOND SCHOENECK & KING, PLLC, ONE LINCOLN CENTER, SYRACUSE, NY, 13202, US

(73) Assignee: International Business Machines Corporation, Armonk, NY (US)

(21) Appl. No.: 11/765,537

(22) Filed: Jun. 20, 2007

(30) Foreign Application Priority Data
Jun. 22, 2006 (CN) 200610094080.7

(51) Int. Cl. G06F 17/30

(52) U.S. Cl. 707/4

(57) ABSTRACT

The invention provides a data processing method and system based on a networked relational dimension. An aggregation on the attributes of the entities having networked relations and/or the attributes of the relations between the entities is described; a transitive rule of relations between the entities having networked relations is described as a restriction; the aggregation and the restriction are translated into the queries in a database manipulating language. According to the invention, a networked relational dimension can be described by using concise description, and the description can be effectively converted into standard data manipulation language.

### PRIORITY CLAIM

The present application claims priority to Applicant's co-pending Chinese Patent Application Number 200610094080.7, filed Jun. 22, 2006, the entirety of which is hereby incorporated by reference.

### FIELD OF THE INVENTION

The present invention relates to data manipulation on database management system (DBMS), and specifically relates to a system and method to support the aggregation operation restricted by a networked relational dimension for multi-dimensional DBMS.

### BACKGROUND OF THE INVENTION

In general, a dimension can be classified into two types in view of values of the attributes in the dimension controlled by current DBMS. One is enumeration or number. That is, this type of dimension is characterized in that the values of the attributes in the dimension may be defined in the manner of enumeration or number. For example, a company employee dimension comprises the attributes “employee ID”, “employee name” and “employee gender”. The instance of the “employee ID” may be consisted of the combination of numbers or characters; the instance of the “employee name” may be consisted of the combination of characters, and the instance of the “employee gender” may be presented by such enumeration as “male” or “female”. The aggregation operation on this type of dimension can be conducted through “Set operation”. Another type of dimension is characterized in that the instances of the dimension have hierarchy relations. That is, the attributes in the dimension construct a partial order graph having the relation of generalizing/specializing. For instance, a city structure dimension may include the attributes “district/county”, “street” and “community”, in which the “district/county” is located in a higher level than the “street” and the “community”, while the “street” is located in a higher level than the “community”. If each of the instances in this dimension is defined as a node, all the instances in the dimension construct a directed acycline graph (DAG) (or called a partial order graph).

Traditional OLAP generally handles and analyzes these two types of dimensions, by taking the aggregation operation on the tables in these dimensions using the attributes in the dimensions so as to generate the analysis result in responding to a request of a user.

However, there is one type of dimension in the multidimensional DBMS system which can not be handled by the traditional OLAP. We call this type of dimension as the networked relational dimension, which is characterized in that some attributes (hereinafter entity or role) in the dimension are restricted by a networked relation with certain transitive features.

We will now further illustrate the characters of the three types of dimensions.

Assuming FIG. 1A is the dimension table (Location table) of the locations of the sub-companies of a multinational company, FIG. 1B is the dimension table (Company table) of the assets of the sub-companies of the multinational company, and FIG. 1C is the dimension table (shareholding table) of the shareholding relations of the sub-companies of the multinational company. The attributes in the dimension of the locations of the sub-companies include LID (the number of the location of the company), country, state and city. The attributes in the dimension of the assets of the sub-companies include CID (the number of company), location and asset. The attributes in the dimension of the shareholding relations of the sub-companies include RID (the number of the shareholding relation), holder, owner, type (the type of the shareholding) and percent. (the percentage of shareholding). DS represents the derivative share, while PS represents the prefer share. FIG. 2A shows the partial order graph of the entity instances obtained from the entities and relations in the dimension where the dimension table of the locations of the sub-companies is.

In the partial order graph, the relations among the entity instances in the dimension of the locations of the sub-companies are shown in hierarchy.

According to the traditional OLAP system, the aggregation operation on the assets of each of the sub-companies in the table of the assets of the sub-companies as shown in FIG. 1B may be conducted by taking the company locations in the dimension of the locations of the sub-companies shown in FIG. 1A as the restrictions.

However, when the aggregation operation on the assets of each of the sub-companies in the table of the assets of the sub-companies as shown in FIG. 1B is conducted by taking the shareholding relations in the dimension shown in FIG. 1C as the restrictions, the traditional OLAP cannot effectively describe the complicated networked relations and cannot effectively retrieve database.

FIG. 2B shows the graph of the relations of the entity instances in FIG. 1C.

As shown in FIG. 2B, there are several kinds of complicated networked relations among the entity instances A, B, C and D, but not the partial relations shown in FIG. 2A.

For example, company A holds 50% DS of company B; company B holds 30% PS of company C; but company B holds 20% DS of company D, company D holds 10% PS of company A. In addition, there are indirect shareholding relations among some companies, for example, company A indirectly holds the shares of the companies C and D.

When there is a need to retrieve the assets of the sub-companies indirectly held by company A based on the networked indirectly shareholding relation, the traditional OLAP system cannot makes effective aggregation operation on the networked relational dimension. In other words, the traditional OLAP system cannot clearly define or describe the restrictions on the networked relational dimension. Programmers need to have superior programming skills and complete understanding on the relations among entities if they want to manipulate this kind of networked relational dimension. However, it is usually impossible to realize for a complicated and huge networked relational dimension.

There is no appropriate solution in the traditional OLAP system to fast and expediently retrieve certain entity relations satisfying some restrictions from the entity relations having networked structure.

### SUMMARY OF THE INVENTION

To solve the problems mentioned above in the prior art, an object of the invention is to provide a system and method to support the aggregation operation restricted by a networked relational dimension for multidimensional DBMS.

To obtain the object of the above, the present invention provides a data processing method based on a networked relational dimension, characterized in comprising: an aggregation describing step for describing an aggregation on the attributes of the entities with networked relations and/or the attributes of the relations between said entities; a restriction describing step for describing a transitive rule of relations between the entities with networked relations as a restriction; a translating step for translating the aggregation and the restriction into the query in a database manipulating language.

The present invention further provides a data processing system based on a networked relational dimension, characterized in comprising: an aggregation describing means for describing an aggregation on the attributes of the entities with networked relations and/or the attributes of the relations between said entities; a restriction describing means for describing a transitive rule of relations between the entities with networked relations as a restriction; a translating means for translating the aggregation and the restriction into the query in a database manipulating language.

According to the invention, a networked relational dimension can be described by using concise description method, and the description obtained can be effectively translated into the statements in a standard data manipulation language.

According to the invention, a complicated database query can be automatically generated, so that the requirements on programming skills and human labors are reduced.

According to the invention, the data table that has a great volume and a complicated networked relational structure can be manipulated.

According to the invention, the capability of modeling multi-dimensional data is enhanced so as to provide an effective means for data digging.

### BRIEF DESCRIPTION OF THE DRAWINGS

These and other advantages of the invention will be more apparent by the detained description of the preferred embodiments of the invention, with reference to the accompanying drawings, in which

FIG. 1A is the dimension table of the locations of the sub-companies of a multinational company;

FIG. 1B is the dimension table of the assets of the sub-companies of the multinational company;

FIG. 1C is the dimension table of the shareholding relations of the sub-companies of the multinational company;

FIG. 2A shows the partial order graph of the entity instances obtained from FIG. 1A;

FIG. 2B shows the graph of the relations of the entity instances in FIG. 1C;

FIG. 3 is the flowchart of the method according to the invention;

FIG. 4 is the block diagram of the system according to the first embodiment of the invention;

FIG. 5 is the flowchart for describing aggregation;

FIG. 6 is the flowchart for describing restriction;

FIG. 7 is the flowchart for translation the restriction description into SQL query;

FIG. 8 shows the flowchart for constructing the WHERE block in a query in structural query language;

FIG. 9 shows the flowchart in part A in FIG. 8;

FIG. 10 illustrates the computer system for implementing the first embodiment according to the invention;

FIG. 11 shows the block diagram of the system according to the second embodiment of the invention.

### DETAILED DESCRIPTION OF THE PREFERRED EMBODIMENT

In the following description, lots of details are provided in order to help to thoroughly understand the invention. However, it will be apparent for persons in the art to easily understand the invention even if these details are not described. Also any of the specific terms used herein are just for the convenience of description. Therefore the invention is not limited to any specific application identified and/or implied by these terms. For example, the following description takes the share holding as an example. However, the invention may apply to any dimension table having networked relations, such as the networked relational dimension table including the selling/purchasing relations between sellers and purchasers, and the networked relational dimension table including the insurance relations between insurance companies and insurants.

The functions of the invention may be implemented by hardware or software or their combination, except special illustration. However, in the preferred embodiments, these functions may be implemented by Integrated Circuits such processors as computers or electronic digital processors running codes like computer program codes. In general, the method running for implementing the embodiments of the invention may be parts of operating systems or specific applications, or programs, or modules or objects or series of instructions. Software implementing the invention includes instructions readable by local computers, and therefore the instructions are executable ones. In addition, programs include variables and data structures stored locally or may be stored in memories.

The first embodiment according to the invention will now be described.

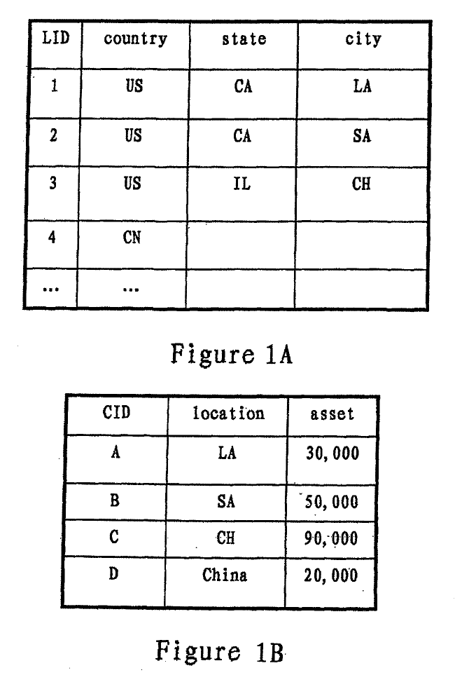

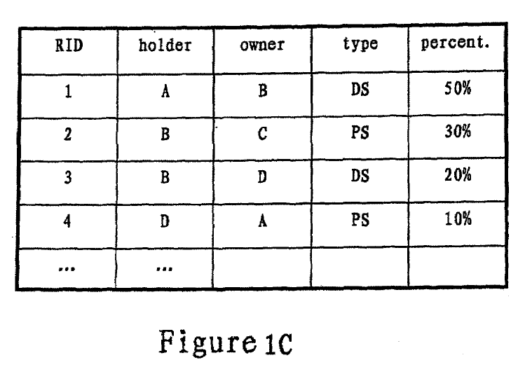

In FIG. 1C, we assume a holder is the role 1, an owner is the role 2, As shown in FIG. 1C, in the networked relational dimension, there exist complicated transitive rules between the role 1 and the role 2. These rules include:

(1) the direct transitive rule between the role 1 and the role 2 for example, in the first record in FIG. 1C, there exists a direct transitive rule between A and B;

(2) the indirect transitive rule between the role 1 and the role 2 for example, as shown in FIG. 1C, there exists an indirect transitive rule between A and C, which is obtained from the direct transitive rule between A and B in the first record and the direct transitive rule between B and C in the second record.

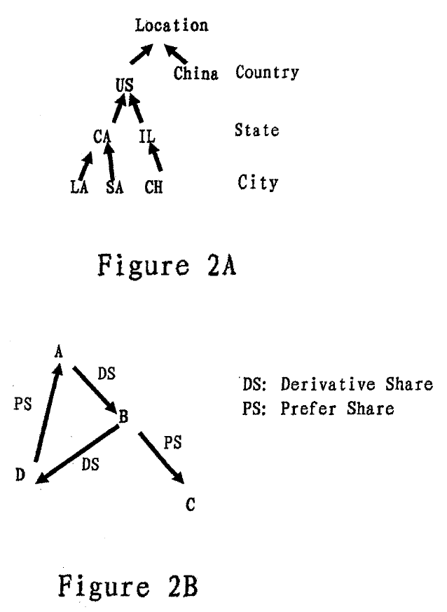

Further, the above indirect transitive rule may be further classified into a circled indirect transitive rule and a non-circled indirect transitive rule. For example, as shown in FIG. 2B, there is a non-circled indirect transitive rule among A, B and C, while there is a circled indirect transitive rule among A, B and D. It will be understood from the latter description that it is meaningful to prevent the database query program obtained after the translation from running into endless loop.

The present invention supports the aggregation operation restricted by the networked relation such as that between the role 1 and the role 2.

It needs to be noted that there are two kinds of attributes in a networked relational dimension. One is called the role or the entity that has certain transitive features and the relations between the roles/entities. The other is called value attribute (hereinafter called attribute), which is the character other than the role in the networked relational dimension and includes at least an attribute of an entity (role) or an attribute of a relation. The value attribute, for example, represents the attribute of a type or a value.

In the networked relational dimension, an entity (role) has the attributes to be aggregated. The relations connecting the roles are the condition for aggregation operation, and the relations themselves have the attributes to be restricted or aggregated. In this kind of dimension, the relations of the entities represented by an instance space have a networked structure. If the instances of entities are modeled as vertices, and the instances of the relations are modeled as edges, the vertices and the edges construct a labeled and weighted graph. For example, in FIG. 1C, in the instance of the relation between A and B, the label attribute (type attribute) is DS, while the weight attribute (value attribute) is 50%.

The invention tries to retrieve the sub-graphs that match with certain restrictions.

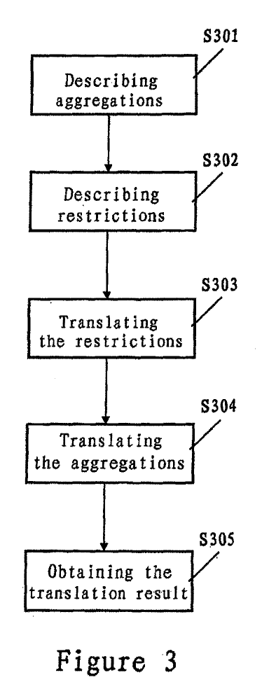

FIG. 3 shows the flow chart of the method according to the invention.

In the step S301, the aggregation on the attributes of entities is described. That is, which attributes (or measures) of the entities (roles) are to be aggregated in which manner is described in this step.

In the step S302, the restrictions on the networked relational dimension are described. That is, the transitive rules of the entities and the relations and the restrictions on other attributes are described.

In the step S303, the restrictions are translated into, for example, a SQL query described in a standard database manipulation language, based on stored translation rules.

In the step S304, the aggregation is translated into, for example, a SQL query described in a standard database manipulation language, based on stored translation rules.

In the step S305, the SQL queries obtained in the steps S303 and S304 are combined to generate a SQL program as the result of aggregation operation. The SQL program is, for example, an immediate SQL query (Select) or a Create View operation to be used in future.

For persons in the art, the above steps may be combined arbitrarily. For example, the step S301 and S302 may be combined to construct a describing step; while the step S303 and S304 may be combined to construct a translating step. The steps will be described in detail according to the system of the invention.

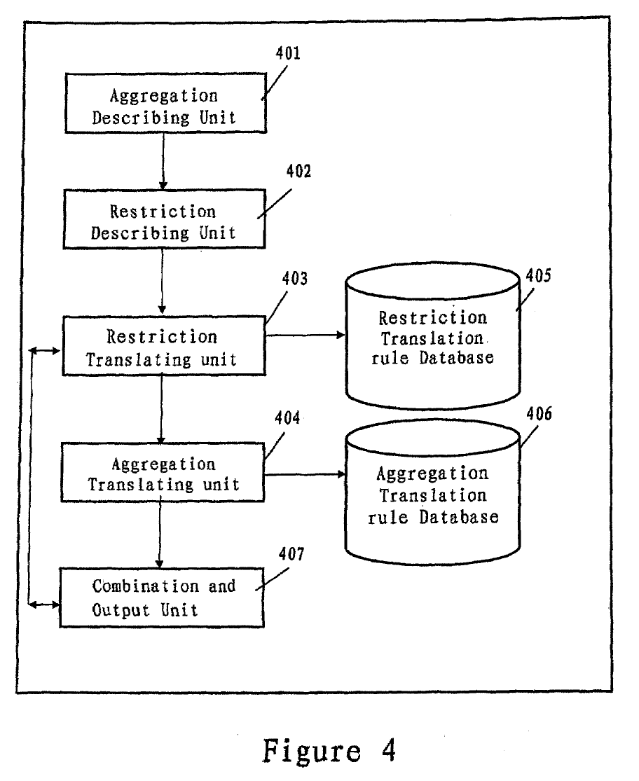

FIG. 4 shows the systematical block diagram of the system according to the invention.

The system for aggregation operation according to the invention includes an aggregation describing unit 401, a restriction describing unit 402, a restriction translating unit 403, an aggregation translating unit 404, a restriction translation rule database 405, an aggregation translation rule database 406, and a combination and output unit 407.

The aggregation describing unit 401 describes aggregation. In particular, it determines the objects of aggregation operation, and describes which attributes (or measures) are to be aggregated in which manner.

According to the invention, the description may be conducted by using a conventional describing language like SQL, known OLAP language, or Logic Program such as Datalog.

The aggregation description will be explained by taking FIGS. 1A to 1C as examples.

For example, it is assumed that the aggregation operation on the sum of the assets of all the sub-companies indirectly shareheld by the company A according to the types of the shareholding is to be conducted.

The description on aggregation using Datalog is as follows:

```
? (t, sum<a>) :-
    IndirectSharehold(holder:“A”, owner:x, type:t),
    Company(cID:x, asset:a).
```

Wherein, which attributes are to be aggregated in which manner is described in the header portion. Here, the sum of the asset “a” is calculated for those owners having the shareholding type t.

In the body portion, which attributes and roles of which dimensions are used for aggregation operation is described. Here, the Shareholding dimension having networked relations and the Company dimension having common relations are used to conduct the aggregation operation. In the Shareholding dimension, the attribute “type” is used, and the roles “holder” and “owner” are used; while in the Company dimension, the attribute “asset” is used and the role “cID” is used.

According to the invention, an iterative aggregation may be conducted when describing aggregation. That is, a further aggregation may be conducted on the basis of an answer set of aggregation operation.

For example, when the owner who has the maximum total asset in all the owners indirectly shareholding the holder “A” is to be retrieved, the iterative aggregation is described as follows:

```
? (max<s>) :-
    AssetSum(sum:s).
AssetSum(type:t, sum<a>) :-
    IndirectSharehold(holder:“A”, owner:x, type:t),
    Company(cID:x, asset:a).
```

The above example is an aggregation operation iterated two times. However, it will be apparent for persons in the art to implement an iterative aggregation in the following manner, even if the iterative times are more than two: that is, a next aggregation operation is implemented further based on an answer set of a previous aggregation operation until all the aggregation operations are complete.

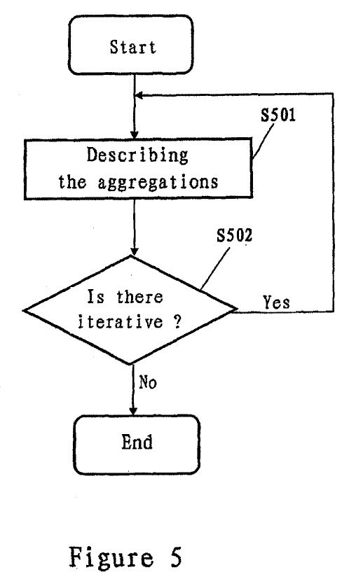

FIG. 5 shows the flow chart of aggregation description.

At first, in the step S501, the current aggregation is described.

Then in the step S502, it is determined whether or not there is an iterative aggregation operation. If there is, the step returns to S501 to continue describe a next aggregation. If not, the process ends.

The restriction describing unit 402 describes the restrictions for an aggregation operation.

In particular, the restriction describing unit 402 describes the restrictions on the dimension(s) described in the body portion of the aggregation description.

The description of the restrictions on a networked relational dimension includes the description on the transitive rules of the bi-ary relations between the roles of the dimension. The transitive rules herein mean the logic rules for describing the transitive relations between the roles and are the restriction conditions when searching a specific entity instance (sub-graph) in a networked relational dimension table.

In addition, when describing the restrictions, it can describe some other attributes of the networked relational dimension as the additional restrictions for searching a specific entity instance (sub-graph).

The restrictions on the other attributes include the restrictions to the labels (type attributes) and the weights (value attributes) in a multi-labeled and multi-weighted graph, and the restrictions to the attributes of the roles themselves.

The multi-labels in the multi-labeled and multi-weighted graph are the type attributes of the relations of the roles shown in FIG. 3B, the multi-weights are the value attributes of the relations of the roles. In particular, the attribute “type” is the label between the role “holder” and the role “owner”, and the attribute “percent.” is the weight between the role “holder” and the role “owner”.

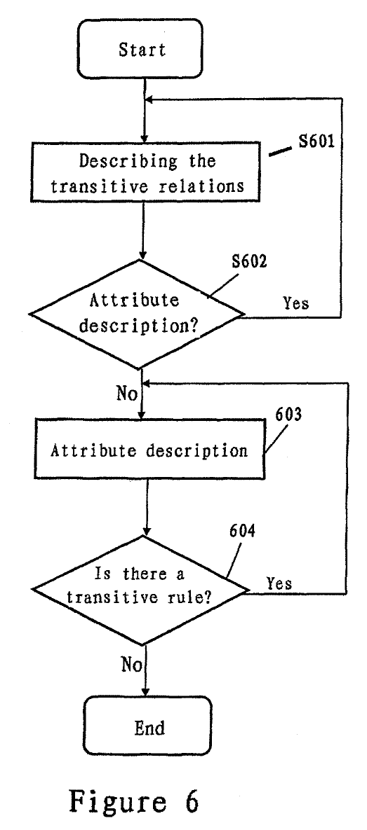

FIG. 6 shows the flow chart for describing the restrictions.

At first, in the step S601, one of the transitive rules between the roles in the body portion described in the aggregation description is described.

Then in the step S602, it is judged whether or not there are the other attributes relative to the one of the transitive rules in the aggregation description that need to be described. If it is yes, then the process goes to the step S603 to describe the other attributes. Otherwise, the process goes to the step S604.

In the step S604, it is judged whether or not there exist other transitive rules between the roles in the body portion described in the aggregation description. If it is yes, then the process goes to the step S601 to continue the description. Otherwise the process ends.

The specific restrictions on the “Indirect_sharehold(Holder:“A”, Owner:x, Type:t)” in the aggregation description are described as follows, according to the above process.

```
IndirectSharehold(holder:x, owner:y, type:t):-
  Shareholding(holder:x, owner:y, type:t).
IndirectSharehold(holder:x, owner:y, type:t):-
  IndirectSharehold(holder:x, owner:z, type:t),
  Shareholding(holder:z, owner:y, type:t).
```

In above description, the first two lines describe the transitive rule between the role x and the role y which have the direct transitive relation, as well as the limitation on the attribute “type”. We call the transitive rule between the role x and the role y which have the direct transitive relation as a non-recursive rule.

In above description, the last three lines describe the transitive rule between the role x, the role y and the role z which have the indirect transitive relations, as well as the limitation on the attribute “type”. We call the transitive rule between the role x and the role y which have the indirect transitive relation as a recursive rule.

When describing the restrictions, the other attributes may be further restricted, which may be determined in response to the requirement of aggregation operation. For example, the value attribute of the “percent.” may be further restricted to no later than a predefined value,

It will be apparent for persons in the art to conduct the above description by using any logical description language, without being limited to the above embodiments.

The restriction translation rule database 405 and the aggregation translation rule database 406 store the translation rules for translating the restriction description and the aggregation description into the statements in a standard database manipulating language, respectively.

The restriction translating unit 403 translates the restriction description into a query described in a standard database manipulating language, based on the translation rules stored in the restriction translation rule database 405. The aggregation translating unit 404 translates the aggregation description into a query described in a standard database manipulating language, based on the translation rules stored in the restriction translation rule database 406.

In the restriction translation rule database 405, the rules for conducting the following translation are stored:

(1) Every non-recursive rule is expressed in relational algebra and thus can be translated into SQL SELECT query.

(2) The SELECT block is constructed by using the table names and the column names that the arguments in the head portion are bound to the arguments in the predicates of the body portion in the restriction description.

(3) The FROM block is constructed by collecting the table names of the tables that the predicates in the body portion in the restriction description denote. If a table name is used many times, the alias may be defined for the table in the FROM block.

(4) The WHERE block is constructed so that, if the predicates in the body portion in the restriction description are comparison predicates, the internal operation is added as the condition portion; if there is a relation between the arguments mentioned in the predicates, the operation of “=” is introduced to add the relation into the condition portion.

(5) The SQL UNION ALL operator is employed to join the result of each transitive rule when there is the definitions on more than one transitive rule in a restriction description.

(6) The recursive rule can be expressed in CTE (Common Table Expression) which is supported in SQL99 standard, and is translated into SQL WITH . . . AS query.

(7) To avoid endless loop or record the circle, the arguments “PATH” and “LOOP” are put into the SELECT block, which are used to record the path of changeable variables in a recursive predicate.

The restriction translating unit 403 translates the restriction description into, for example SQL query in a standard database manipulating language, based on the translation rules stored in the restriction translation rule database 405.

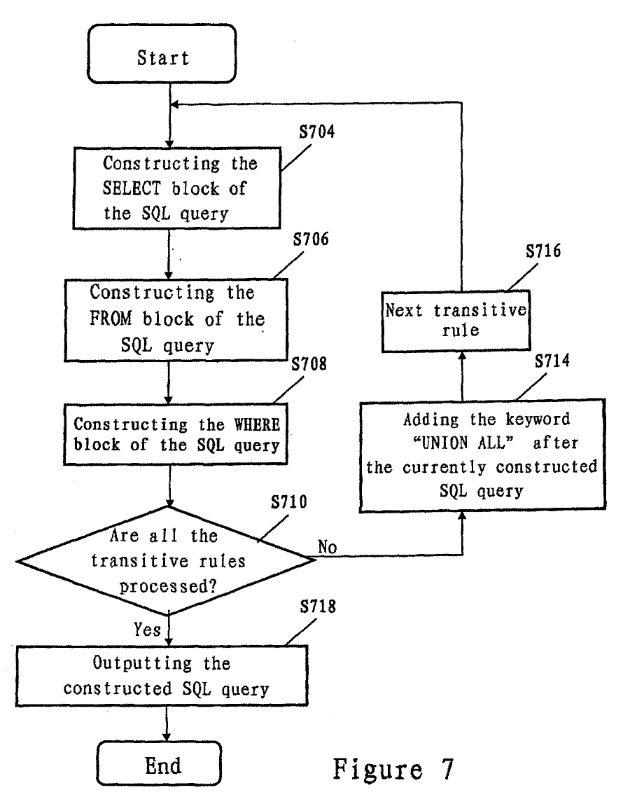

By referring to FIGS. 7 to 9, it will now describe in detail how the restriction translating unit 403 translates the restriction description into a SQL query.

It will now describe the process of translating the restriction description into a SQL query according to the invention according to FIG. 7.

In the step S704, the SELECT block of the SQL query for a current transitive rule which is generally a minimum unit that may be translated into a SQL query or part of the SQL query of an aggregation operation is constructed. The arguments (variables) in the header portion of the restriction description are limited by the predicates including the arguments in the body portion. As a result, in this step, the table names and the column names corresponding to the arguments in the header portion of the restriction description are used as the attributes following the keyword SELECT.

In the step S706, the FROM block of the SQL query for the current transitive rule is constructed. The table names that must be included in the FROM block are the names of the tables corresponding to the predicates in the body portion of the restriction description.

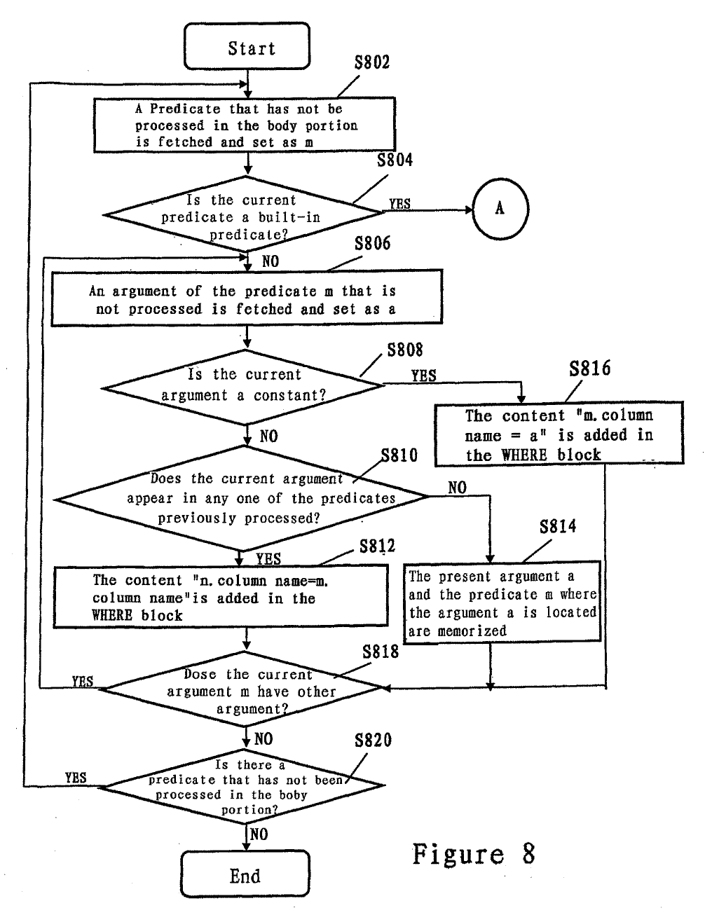

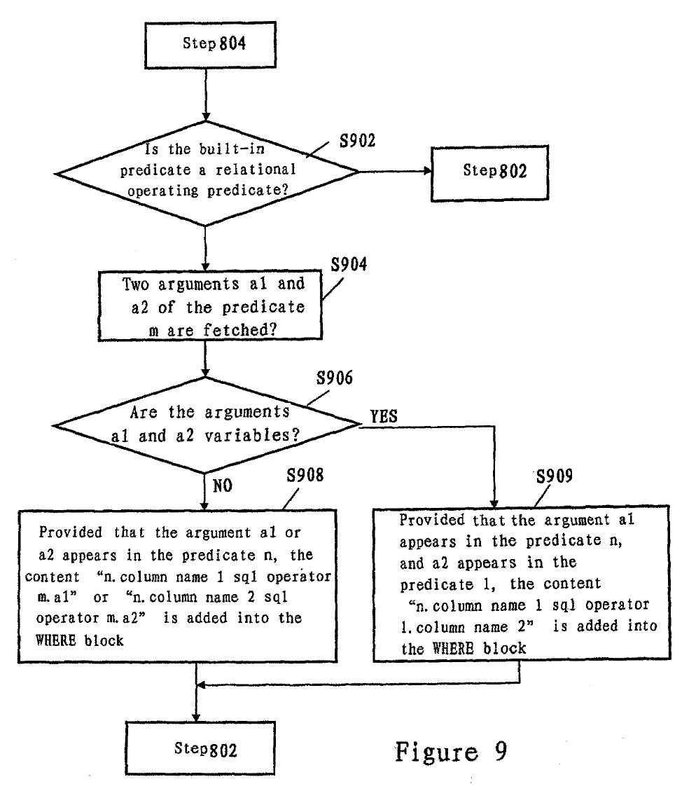

In the step S708, the WHERE block of the SQL query for the current transitive rule is constructed. It is a little complicated to construct the WHERE block. FIGS. 8 and 9 show the flow chart for constructing the WHERE block according to one embodiment of the invention, which will be described later.

In the step S710, it is judged whether or not all the transitive rules in the restriction description are processed. If the judgment result is “yes”, then the step S718 is executed. If the judgment result is “no”, then the step S714 is executed.

In the step S714, the operator keyword “UNION ALL” is added after the SQL query currently constructed.

In the step S716, a next transitive rule in the restriction description is selected.

Then the process returns to the step S704 to continue.

In the step S718, the SQL query constructed for the restrictions is output.

It will now describe the flow chart for constructing the WHERE block according to one embodiment of the invention by referring to FIGS. 8 and 9.

By referring to the contents described on FIG. 7, the body portion of the restriction description described in the following can be understood as what only includes one transitive rule in the restriction description.

FIG. 8 shows the flow chart for constructing the WHERE block of a standard database query according to one embodiment of the invention.

In the step S800, the process starts.

In the step S802, a predicate that has not been processed in the body portion of the restriction description is fetched and set as m.

In the step S804, it is judged whether or not the currently fetched predicate is a built-in predicate. If the judgment result is “yes”, then the process goes to the part A (to be illustrated by referring to FIG. 9 later). If the judgment result is “no”, then the step S806 is executed.

In the step S806, an argument of the predicate m that is not processed is fetched and set as a.

In the step S808, it is judged whether or not the current argument a is constant. If the judgment result is “yes”, then the step S816 is executed. If the judgment result is “no”, then the step S810 is executed.

In the step S816, the content “m.column name=a” is added in the WHERE block, in which the “column name” is the name of the column corresponding to the current argument a. And then the process continues to execute the step S818.

In the step S810, it is judged whether or not the current argument appear in any predicate n previously processed. If the judgment result is “yes”, then the step S812 is executed. If the judgment result is “no”, then the step S814 is executed.

In the step S812, the content “n.column name=m.column name” is added in the WHERE block, in which the two “column names” are the names of the columns that the current argument correspond to in the predicates n and m.

In the step S814, the present argument a and the predicate m where the argument a is located are memorized.

In the step S818, it is judged whether or not the current argument m has other arguments. If the judgment result is “yes”, then the step S806 is executed. If the judgment result is “no”, then the step S820 is executed.

In the step S820, it is judged whether or not there is a predicate that has not been processed in the body portion of the restriction description. If the judgment result is “yes”, then the step S802 is executed. If the judgment result is “no”, then the process ends.

FIG. 9 shows the flow chart in the part A of FIG. 8.

In the step S902, it is judged whether or not the built-in predicate is a relational operating predicate such as ==,<>,>,>=,<,<=. It will be apparent for the persons in the art that only the relational operating predicates out of the built predicates in the WHERE block need to be processed. In this kind of relational operating predicates, there are usually two variables. And then if in the step S902 the judgment result is “no”, the process returns to the step S802 in FIG. 8 to continue fetch a next predicate that is not processed. If the judgment result is “yes”, the process goes to the step S904.

In the step S904, two arguments a1 and a2 of the predicate m are fetched.

In the step S906, it is judged whether or not the arguments a1 and a2 are variables. If the judgment result is “no”, then the step S908 is executed. If the judgment result is “yes”, then the step S910 is executed.

In the step S908, provided that the argument a1 or a2 appears in the predicate n, the content “n.column name 1 sq1 operator m.a1” or “n.column name 2 sq1 operator m.a2” is added into the WHERE block, in which the “column name 1” is the name of the column in the table that corresponds to the predicate n corresponding to the argument a1, and the “column name 2” is the name of the column in the table that corresponds to the predicate n corresponding to the argument a2, and the “sq1 operator” is the sq1 operator corresponding to the relational operating predicate.

In the step S910, provided that the argument a1 appears in the predicate n, and a2 appears in the predicate 1, the content “n.column name 1 sq1 operator 1.column name 2” is added in the WHERE block, in which the “column name 1” is the name of the column in the table that corresponds to the predicate n corresponding to the argument a1, and the “column name 2” is the name of the column in the table that corresponds to the predicate 1 corresponding to the argument a2, and the “sq1 operator” is the sq1 operator corresponding to the relational operating predicate.

After the step S908 or S910, the process returns to FIG. 8 to continue the step S820.

The recursive query can be expressed in SQL99 standard of SQL standard. So the recursive restriction description may be expressed as Common Table Expression (CTE) which is supported in SQL99 standard. According to the embodiment of the invention, the recursive restriction description may be expressed as Common Table Expression, in which the “WITH table name (a1, a2, . . . ) AS” clause is used to define the whole recursive query. The same constructing process as that of the non-recursive restriction description may apply in the recursive query to generate the SELECT block, the FROM block and the WHERE block. The “table name” defined in the WITH block may be referred to in these blocks. Finally, the SELECT block is generated in order to generate the columns needed in the recursive query result.

According to one embodiment of the invention, two arguments (or columns) may be added in the WITH block in order to avoid the endless loop when executing a translated recursive query, in which one argument (for example, the argument “path”) records the path where a variable recursively changes in the recursive querying process, while the other argument (for example, the argument “loop” defined in Boolean value) records whether or not the current value of the variable has ever appeared in the recorded argument “path”. It can be understood that if the current value of the variable has ever appeared in the recorded “path”, it means the recursive querying has fallen into the endless loop; otherwise, it means that recursive querying is safe.

According to the translation method described above, the restriction description in the example is translated into the following SQL query. It should be noted that the following example employs the arguments “path” and “loop” to avoid the occurrence of endless loop.

```
WITH IndirectSharehold(holder, owner, type, path, loop) AS
(
  SELECT sh.holder, sh.owner, sh.type, HEX(sh.owner), 0
  FROM Shareholding sh
  UNION ALL
  SELECT ish.holder, sh.owner, sh.type, ish.path || sh.owner,
  LOCATE_BLOCK(sh.owner, ish.path)
  FROM IndirectSharehold ish, Shareholding sh
  WHERE sh.holder = ish.owner and sh.type = ish.type and ish.loop = 0
)
SELECT holder, owner, type
FROM IndirectSharehold
```

in which, the symbol ∥ is the operator representing that two strings are concatenated. LOCATE_BLOCK ( ) is a predefined function which locates at another string in one string and returns a Boolean value. Other functions that supported by SQL or further developed in the later may be employed in the translated SQL query, so as to enhance the performance of SQL query. The functions may be implemented by the specific algorithm or program for translating the recursive logic rules.

The persons in the art may design different kinds of algorithms or programs to realize the process of the strategy for translating the recursive logical rules into SQL statements. The description on the specific process is omitted herein. However, it should be understood that all the specific process flows are included in the scope of the invention.

In the aggregation translation rule database 406, the rules for conducting the following translation are stored:

(1) The rules for constructing the SELECT block, the FROM block, and the WHERE block are the same as those for translating the restriction description.

(2) A template table is used to obtain the answer set of entity instance restricted by a networked relational dimension in a SQL query.

(3) An aggregation functor (sum, avg . . . ) having the keyword of DISTINCT is inserted in the SELECT block.

(4) The clause SQL SELECT . . . GROUP is used in aggregation restriction, in which the attributes to be aggregated is added after the “GROUP”.

The aggregation translating unit 404 translates the aggregation description into a query described in a standard database manipulating language such as a SQL query described in SQL, based on the translation rules stored in the restriction translation rule database 406.

The following SQL query is generated after the aggregation description is translated according to the above rules:

```
WITH IndirectSharehold(holder, owner, type, path, loop) AS
(
  SELECT sh.holder, sh.owner, sh.type, HEX(sh.owner), 0
  FROM Shareholding sh
  UNION ALL
  SELECT ish.holder, sh.owner, sh.type, ish.path || sh.owner,
  LOCATE_BLOCK(sh.owner, ish.path)
  FROM IndirectSharehold ish, Shareholding sh
  WHERE sh.holder = ish.owner and sh.type = ish.type and ish.loop = 0
)
SELECT ish.type, SUM(DISTINCT c.asset)
FROM Company c, IndirectSharehold ish
WHERE ish.owner = c.cid and ish.holder = “A”
GROUP BY ish.type
```

The further aggregation operation (iterate aggregation such as dual-aggregation or multi-aggregation) on one aggregation result may be conducted in the same method. The example is as follows:

```
WITH IndirectSharehold(holder, owner, type, path, loop) AS
(
  SELECT sh.holder, sh.owner, sh.type, HEX(sh.owner), 0
  FROM Shareholding sh
  UNION ALL
  SELECT ish.holder, sh.owner, sh.type, ish.path || sh.owner,
  LOCATE_BLOCK(sh.owner, ish.path)
  FROM IndirectSharehold ish, Shareholding sh
  WHERE sh.holder = ish.owner and sh.type = ish.type and ish.loop = 0
) ,
AssetSum(type, sum) AS
(
  SELECT ish.type, SUM(DISTINCT c.asset)
  FROM Company c, Indirect_sharehold ish
  WHERE ish.owner = c.cid and ish.holder = “A”
  GROUP BY ish.type
)
SELECT MAX(sum)
FROM AssetSum
```

In the example, the template table “AssetSum” (sum of the assets) is used for the second aggregation operation.

The combination and output unit 407 combines the results generated by the restriction translating unit 403 and the aggregation translating unit 404, to generate SQL program, for example, an immediate SQL query (Select) or a view (Create View).

According to the invention, the aggregation operation on networked relational dimension may be conducted by simple aggregation description and translation.

It will be understood for persons in the art that the restriction translating unit 403 and the aggregation translating unit 404 may be combined to be one translating unit to realize the function of them, and/or the restriction translation rule database 405 and the aggregation translation rule database 406 may be combined to be one translation rule database to store all the translation rules. Further, the combination and output unit 407 may be combined with the two translating units to be one functional unit.

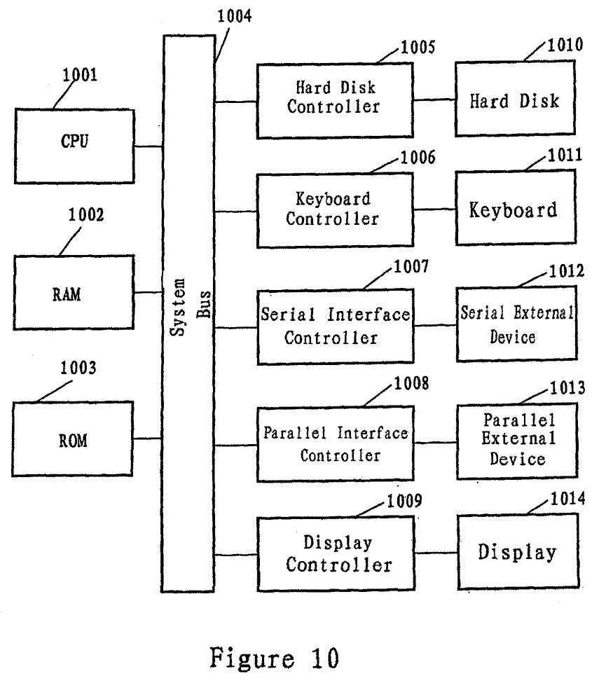

FIG. 10 illustratively shows the computer system for implementing the embodiments of the invention. As shown in FIG. 10, the computer system comprises a CPU (Central Processing Unit) 1001, a RAM (Randomly Accessing Memory) 1002, a ROM (Read only Memory) 1003, a system bus 1004, a HD (Hard Disk) controller 1005, a keyboard controller 1006, a serial interface controller 1007, a parallel interface controller 1008, a display controller 1009, a hard disk 1010, a keyboard 1011, a serial external device 1012, a parallel external device 1013 and a display 1014. Among these components, the system bus 1004 connects to the CPU 1001, the RAM 1002, the ROM 1003, the HD controller 1005, the keyboard controller 1006, the serial interface controller 1007, the parallel interface controller 1008 and the display controller 1009. The hard disk 1010 connects to the HD controller 1005; the keyboard 1011 connects to the keyboard controller 1006; the serial external device 1012 connects to the serial interface controller 1007; the parallel external device 1013 connects to the parallel interface controller 1008; and the display 1014 connects to the display controller 1009.

The function of each of the components in FIG. 10 is well known in the art. And the structure shown in FIG. 10 is conventional, which may be applied in personal computers, handholding devices such as Palm PC, PDA (Personal Data Assistance), and mobile phones. Some of the components shown in FIG. 10 may be omitted in different applications. The whole system shown in FIG. 10 is controlled by the software generally stored in the hard disk 1010 or the computer readable instructions generally stored in other volatile storage. The software itself may be downloaded from networks. The software stored in the hardware 1010 or downloaded from networks may be uploaded into the RAM 1002 and run by the CPU 1001 so as to realize the function of the software.

Although the computer system defined in FIG. 10 may support the method for aggregation operation restricted by a networked relational dimension according to the invention, the computer system is only one example. It is apparent for persons in the art that other computer systems may be designed for implementing the invention.

The invention may be implemented by a computer program article used by the computer system shown in FIG. 10, which includes the codes for the method of the invention. The codes may be stored in storages in other computer system before being used, for example, in hard disks or other movable storages such as optical disks or floppies, or downloaded via Internet or other networks.

### The Second Embodiment

According to the second embodiment, the describing process and the translating process may be executed in a client and a server respectively.

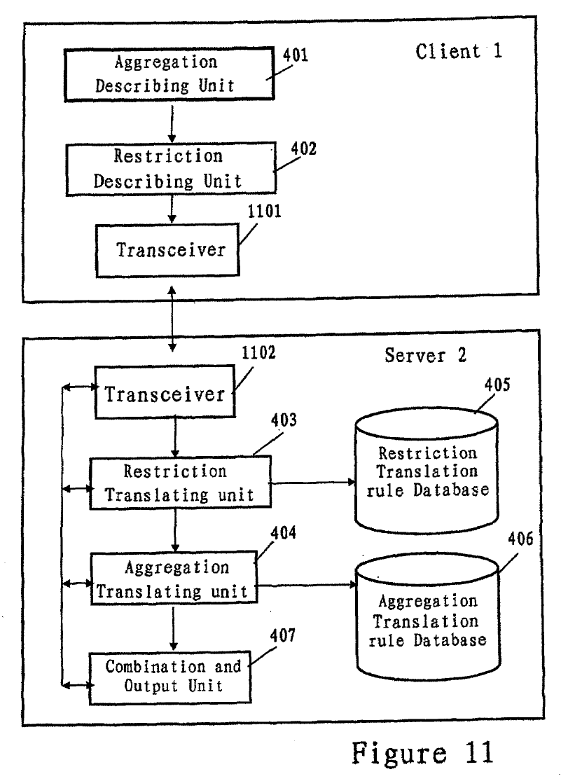

FIG. 11 shows the system block of the second embodiment according to the invention.

The parts that are the same as that of FIG. 4 have the same reference numbers, and the description thereof is omitted.

In the second embodiment, a client 1 comprises the aggregation describing unit 401, the restriction describing unit 402, and a transceiver 1101. A server 2 comprises the restriction translating unit 403, the aggregation translating unit 404, the restriction translation rule database 405, the aggregation translation rule database 406, the combination and output unit 407 and a transceiver 1102.

According to the second embodiment, In the client 1, the description result generated by the aggregation describing unit 401 and the restriction describing unit 402 is sent to the server 2 via the transceiver 1101.

The server 2 receives the description result via the transceiver 1102, which transfers the description result to the restriction translating unit 403 and the aggregation translating unit 404 to be translated. The combination and output unit 407 sends the translated result to the client 1 via the transceiver 1102.

The transceiver 1101 in the client 1 receives the result and stores it into a storage not shown or sends it to a processor that is not shown to process.

According to the second embodiment, the client itself does not need to have the translating function. It only needs to send the descriptions to the server to process so that the cost in the client is saved.

The computer systems in the client and the server may employ that in FIG. 10 or other known computer processing apparatus.

It will be appreciated that, the scope of protection of the invention is defined by the following claims, but not limited to the specific embodiments.

While the embodiments of the invention have been described in detail with reference to attached drawings, various changes and modifications may be made to the above embodiments without departing from the spirit and scope of the invention. Therefore, the scope of the invention is only defined by the attached claims.

1. A data processing method based on a networked relational dimension, comprising the steps of:
an aggregation describing step for describing an aggregation on the attributes of the entities having networked relations and/or the attributes of the relations between said entities;
a restriction describing step for describing a transitive rule of relations between the entities having networked relations as a restriction;
a translating step for translating the aggregation and the restriction into the query in a database manipulating language.

2. The method according to claim 1, characterized in that:
in said restriction describing step, the attributes of the entities or the attributes of the relations between the entities are described as a restriction.

3. The method according to claim 1, wherein:
said translating step includes a recursive transitive rule and a non-recursive transitive rule,
if said database manipulating language is a SQL language, said non-recursive transitive rule is translated into SQL SELECT query, and said recursive transitive rule is translated into SQL WITH . . . AS query.

4. The method according to claim 3, wherein:
in said translating step, a path in said recursive transitive rule is recorded to avoid the occurrence of the endless loop.

5. The method according to claim 1, wherein:
said aggregation describing step comprises an iterate aggregation describing step for taking further aggregation operation based on a result set of a previous aggregation operation.

6. The method according to claim 1, wherein:
if said database manipulating language is a SQL language, said aggregation is translated into SQL SELECT . . . GROUP BY query in said transforming step.

7. A data processing system based on a networked relational dimension, comprising:
an aggregation describing means for describing an aggregation on the attributes of the entities having networked relations and/or the attributes of the relations between said entities;
a restriction describing means for describing a transitive rule of relations between the entities having networked relations as a restriction; and
a translating means for translating the aggregation and the restriction into the query in a database manipulating language.

8. The system according to claim 7, wherein:
said restriction describing means further describes the attributes of the entities or the attributes of the relations between the entities as a restriction.

9. The system according to claim 7, wherein:
said transitive rule includes a recursive transitive rule and a non-recursive transitive rule,
if said database manipulating language is a SQL language, said non-recursive transitive rule is translated into SQL SELECT query, said recursive transitive rule is translated into SQL WITH . . . AS query.

10. The system according to claim 9, wherein:
said translating means further records a path in said recursive transitive rule to avoid the occurrence of the endless loop.

11. The system according to claim 7, wherein:
said aggregation describing means comprises an iterate aggregation describing means for taking further aggregation operation based on a result set of a previous aggregation operation.

12. The system according to claim 7, wherein:
when said database manipulating language is a SQL language, said aggregation is translated into SQL SELECT . . . GROUP BY query.

13. A computer program product including the program codes which are stored in computer readable storage medium, comprising:
an aggregation describing means for describing an aggregation on the attributes of the entities having networked relations and/or the attributes of the relations between said entities;
a restriction describing means for describing a transitive rule of relations between the entities having networked relations as a restriction; and
a translating means for translating the aggregation and the restriction into the query in a database manipulating language.

14. The computer program product according to claim 13, wherein:
said restriction describing means further describes the attributes of the entities or the attributes of the relations between the entities as a restriction.

15. The computer program product according to claim 13, wherein:
said transitive rule includes a recursive transitive rule and a non-recursive transitive rule,
if said database manipulating language is a SQL language, said non-recursive transitive rule is translated into SQL SELECT query, said recursive transitive rule is translated into SQL WITH . . . AS query.

16. The computer program product according to claim 15, wherein:
said translating means further records a path in said recursive transitive rule to avoid the occurrence of the endless loop.

17. The computer program product according to claim 13, wherein:
said aggregation describing means comprises an iterate aggregation describing means for taking further aggregation operation based on a result set of a previous aggregation operation.

18. The computer program product according to claim 13, wherein:
when said database manipulating language is a SQL language, said aggregation is translated into SQL SELECT . . . GROUP BY query.
